(19) United States
(12) Patent Application Publication
(10) Pub. No.: US 2024/0267666 A1
(43) Pub. Date: Aug. 8, 2024

(54) ELECTRONIC DEVICE FOR CONTROLLING BATTERY CHARGE STATE OF EXTERNAL ELECTRONIC DEVICE, AND OPERATING METHOD THEREFOR

(71) Applicant: SAMSUNG ELECTRONICS CO., LTD., Suwon-si (KR)

(72) Inventors: Kiwook HAN, Suwon-si (KR); Sungjin KIM, Suwon-si (KR); Chulhan KIM, Suwon-si (KR)

(21) Appl. No.: 18/639,225

(22) Filed: Apr. 18, 2024

Related U.S. Application Data
(63) Continuation of application No. PCT/KR2022/020823, filed on Dec. 20, 2022.

(30) Foreign Application Priority Data
Dec. 21, 2021 (KR) 10-2021-0183829
Feb. 16, 2022 (KR) 10-2022-0020186

(51) Int. Cl. H04R 1/10; H02J 7/00

(52) U.S. Cl. CPC H04R 1/1025; H02J 7/0047; H02J 7/007182; H04R 1/1016

(57) ABSTRACT

An example electronic device includes a temperature sensor, a battery, a communication circuit, a connecting terminal, a processor, and a memory. The memory stores instructions which, when executed, cause the processor to control the electronic device to determine whether the connecting terminal is electrically connected with the external electronic device, measure a first temperature around the electronic device, receive first battery state information from the external electronic device, based on the measured first temperature being greater than a specified temperature, determine a first charging state of the battery of the external electronic device, and transmit a first signal for controlling the charging state of the battery of the external electronic device to be less than a first specified level, based on determining that the first charging state of the battery of the external electronic device is greater than or equal to the first specified level.

### CROSS-REFERENCE TO RELATED APPLICATION(S)

This application a continuation of International Application No. PCT/KR2022/020823, filed on Dec. 20, 2022, in the Korean Intellectual Property Receiving Office, which is based on and claims priority under 35 U.S.C. § 119 to Korean Patent Application No. 10-2021-0183829, filed on Dec. 21, 2021 and Korean Patent Application No. 10-2022-0020186, filed on Feb. 16, 2022, in the Korean Intellectual Property Office. The disclosures of each of these applications are incorporated by reference herein their entireties.

### BACKGROUND

### 1. Field

The disclosure relates to an electronic device for controlling a battery charging stage of an external electronic device and an operation method thereof.

### 2. Description of Related Art

Recently, with the development of electronic technology, various portable electronic devices, such as smartphones, tablet personal computers (PCs), wearable devices, or wireless earphones, have become widespread.

Among such various portable electronic devices, wireless earphones may receive sound data from an electronic device, such as a smartphone or a tablet PC, through Bluetooth communication. There is a separate electronic device to charge a battery of wireless earphones because the wireless earphones do not include a cable for an electrical connection.

Thus, a cradle capable of storing the wireless earphones and charging the battery of the wireless earphones in a state in which the wireless earphones are being stored may be provided. The cradle may receive power in a wired or wireless manner from the outside to charge the earphone battery in the cradle. The wireless earphones may receive power from the battery in the cradle to charge the battery.

The above information is presented as background information only to assist with an understanding of the disclosure. No determination has been made, and no assertion is made, as to whether any of the above might be applicable as prior art with regard to the disclosure.

### SUMMARY

As described above, as a wireless earphone may receive power from the battery in the cradle, the battery of the wireless earphone may be in a fully charged state. When the wireless earphone is exposed to a high-temperature environment or is left unattended for a long period of time, damage of the battery, such as heat generation, shortened lifespan, or a swelling phenomenon, may be generated.

Aspects of the disclosure may, for example, address certain of the above-mentioned problems and/or disadvantages and can, for example, provide certain advantages described below. Accordingly, an aspect of the disclosure is to provide an example electronic device for monitoring a temperature around an external electronic device in a situation in which the external electronic device is left unattended and controlling a charging state of a battery of the external electronic device, when the external electronic device is exposed to a high-temperature environment or is left unattended for a long period of time, to, for example, reduce potential damage of the battery such as heat generation, shortened lifespan, and/or a swelling phenomenon.

In accordance with an aspect of the disclosure, an example electronic device may be provided. The electronic device may include a temperature sensor, a battery, a communication circuit, a connecting terminal for a connection with an external electronic device, at least one processor electrically connected with the temperature sensor, the battery, and the communication circuit, and memory electrically connected with the processor. The memory may store instructions, which when executed, cause the at least one processor to determine whether the connecting terminal is electrically connected with the external electronic device; measure a first temperature around the electronic device using the temperature sensor, based on a result of determining that the connecting terminal is connected with the external electronic device; receive first battery state information from the external electronic device through the communication circuit, based on the measured first temperature being greater than a specified temperature, the first battery information including information about a charging state of a battery of the external electronic device; determine a first charging state of the battery of the external electronic device, based on the received first battery state information; and transmit a first signal for controlling the charging state of the battery of the external electronic device to be less than a first specified level to the external electronic device through the communication circuit, based on a result of determining that the first charging state of the battery of the external electronic device is greater than or equal to the first specified level.

In accordance with another aspect of the disclosure, an example operation method of an electronic device may be provided. The operation method may include determining whether a connecting terminal of the electronic device is electrically connected with an external electronic device; measuring a first temperature around the electronic device using a temperature sensor of the electronic device, based on a result of determining that the connecting terminal is connected with the external electronic device; receiving first battery state information from the external electronic device through a communication circuit of the electronic device, based on the measured first temperature being greater than a specified temperature, the first battery information including information about a charging state of a battery of the external electronic device; determining a first charging state of the battery of the external electronic device, based on the received first battery state information; and transmitting a first signal for controlling the charging state of the battery of the external electronic device to be less than a first specified level to the external electronic device through the communication circuit, based on a result of determining that the first charging state of the battery of the external electronic device is greater than or equal to the first specified level.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an example electronic device in a network environment according to various embodiments;

FIG. 2 is a block diagram illustrating a configuration of an example Bluetooth electronic device according to various embodiments;

FIG. 3 is a drawing schematically illustrating structures of example Bluetooth electronic devices constituting one set according to various embodiments;

FIG. 4 is a block diagram illustrating a configuration of an example third electronic device according to various embodiments;

FIG. 5 is a drawing schematically illustrating a structure of an example third electronic device according to various embodiments;

FIG. 6 is an operational flowchart of an example electronic device according to various embodiments;

FIG. 7 is an operational flowchart of an example electronic device according to various embodiments; and

FIG. 8 is an operational flowchart of an example electronic device according to various embodiments.

### DETAILED DESCRIPTION

Hereinafter, various example embodiments of the disclosure may be described with reference to accompanying drawings. Accordingly, those of ordinary skill in the art will recognize that modifications, equivalents, and/or alternatives of the various embodiments described herein can be variously made without departing from the scope and spirit of the disclosure. With regard to description of drawings, similar components may be marked by similar reference numerals.

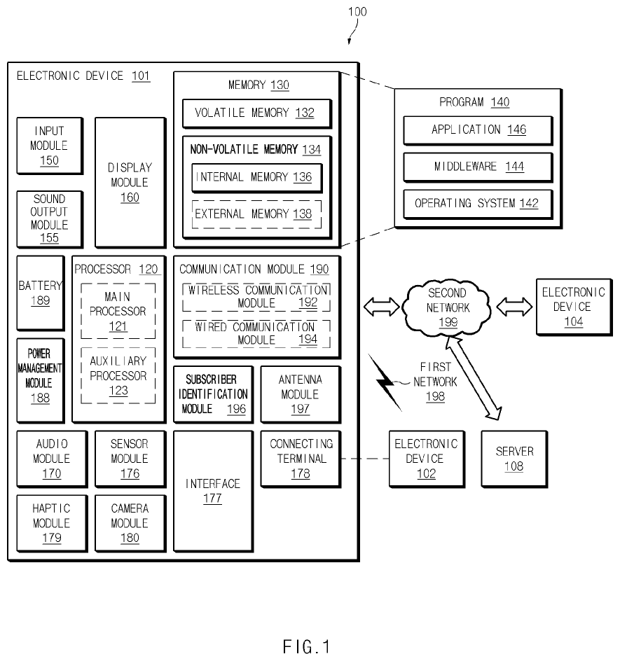

FIG. 1 is a block diagram illustrating an example electronic device in a network environment according to various embodiments.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one (e.g., the connecting terminal 178) of the components may be omitted from the electronic device 101, or one or more other components may be added in the electronic device 101. In various embodiments, some of the components may be implemented as single integrated circuitry. For example, some (e.g., the sensor module 176, the camera module 180, or the antenna module 197) of the components may be implemented as embedded in the display module 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), and an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. When the electronic device 101 includes the main processor 121 and the auxiliary processor, the auxiliary processor 123 may be adapted to consume less power than the main processor 121, or to be specific to a specified function. The auxiliary processor 123 may be implemented as separate from, or as part of, the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., a neural network processing device) may include a hardware structure specified for processing an artificial intelligence (AI) model. The AI model may be generated through machine learning. The learning may be performed by the electronic device 101 performing the AI, and may be performed through an additional server (e.g., the server 108). A learning algorithm may include, for example, a supervised learning algorithm, an unsupervised learning algorithm, a semi-supervised learning algorithm, or a reinforcement learning algorithm, but the disclosure is not limited thereto. The AI model may include a plurality of artificial neural network (ANN) layers. The ANN may include a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-networks or a combination of the above networks, but the disclosure is not limited thereto. The AI model may additionally or alternatively include a software structure, in addition to a hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record, and the receiver may be used for incoming calls. According to an embodiment, the receiver may be implemented as separate from, or as part of, the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., the electronic device 102) (e.g., speaker of headphone) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). The corresponding communication module among these communication modules may communicate with the external electronic device via the first network 198 (e.g., a short-range communication network, such as Bluetooth™, wireless-fidelity (WiFi) direct, or infrared data association (IrDA)) or the second network 199 (e.g., a long-range communication network, such as a legacy cellular network, 5G network, next generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network and a next-generation communication technology, for example, a new radio (NR) access technology after a 4G network. The NR access technology may support high-speed transmission for high capacity data (enhanced mobile broadband; eMBB), terminal power minimizing and multiple terminal access (massive machine type communication; mMTC), or ultra-reliable and low-latency communications (URLLC). The wireless communication module 192 may support a high-frequency band (e.g., mmWave band) to achieve, for example, a higher data rate. The wireless communication module 192 may support various technologies, for example, beamforming, massive multiple-input and multiple-output (MIMO), Full-dimensional MIMO, an array antenna, analog beamforming, or a large-scale antenna, to secure performance in high frequency bands. The wireless communication module 192 may support various requirements defined in the electronic device 101, the external electronic device (e.g., the electronic device 104) or the network system (e.g., the second network 199). According to an embodiment, the wireless communication module 192 may support a peak data rate (e.g., 20 Gbps or more) for eMBB realization, loss coverage (e.g., 164 dB or less) for mMTC realization, or U-plane latency (e.g., 0.5 ms or less, or the round trip of 1 ms or less in each of a downlink (DL) and an uplink (UL)) for URLCC realization.

The antenna module 197 may transmit or receive a signal or power to or from the outside (e.g., the external electronic device) of the electronic device 101. According to an embodiment, the antenna module 197 may include an antenna including a radiating element composed of or including a conductive material or a conductive pattern formed in or on a substrate (e.g., PCB). According to an embodiment, the antenna module 197 may include a plurality of antennas (e.g., an array antenna). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, an RFIC disposed on a first surface (e.g., a bottom surface) of the printed circuit board, or disposed adjacent to the first surface to support the specific high frequency band (e.g., mmWave band), and a plurality of antennas (e.g., an array antenna) disposed on a second surface (e.g., a top surface or a side surface) of the printed circuit board or disposed adjacent to the second surface to transmit or receive a signal having the specified high frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, when the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide an ultra-latency service by using, for example, distributed computing or mobile edge computing. According to various embodiments, the external electronic device 104 may include the Internet of things (IoT). The server 108 may be an artificial server using machine learning and/or a neural network. According to an embodiment, the external electronic device 104 or the server 108 may be included in the second network 199. The electronic device 101 may be applied to an artificial intelligence service (e.g., a smart home, a smart city, a smart car, or healthcare service) based on the 5G communication technology and the IoT-related technology.

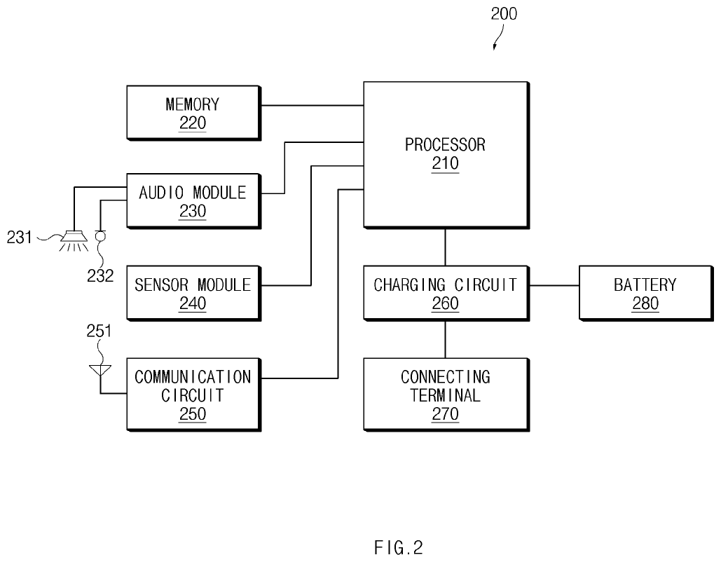

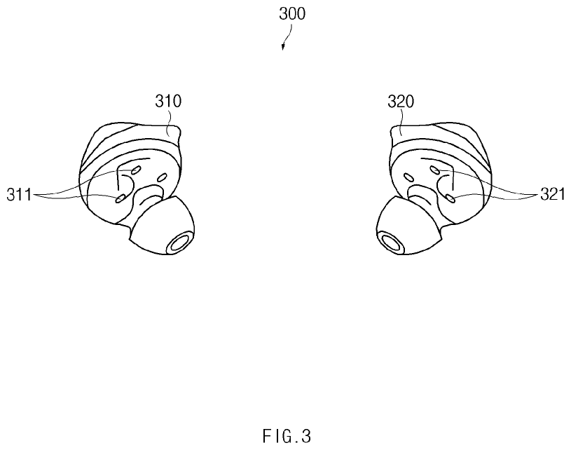

Hereinafter, a description will be given of a Bluetooth electronic device according to various embodiments with reference to FIGS. 2 and 3.

FIG. 2 is a block diagram illustrating a configuration of an example Bluetooth electronic device according to various embodiments.

Referring to FIG. 2, an electronic device 200 (e.g., a first electronic device 310 or a second electronic device 320 of FIG. 3) may include a processor 210 (including, e.g., processing circuitry), memory 220, an audio module 230, a speaker 231, a microphone 232, a sensor module 240 (including, e.g., at least one sensor), a communication circuit 250, at least one antenna 251, a charging circuit 260, a connecting terminal 270, or a battery 280. According to various embodiments, the electronic device 200 may not include at least one of the components of FIG. 2 or may further include one or more other components. According to various embodiments, some of the components may be implemented as one integrated circuit.

For example, the processor 210 may execute software to control at least one other component (e.g., a hardware or software component) of the electronic device 200 connected with the processor 210 and may perform a variety of data processing and calculation. According to an embodiment, as at least a portion of data processing or calculation, the processor 210 may load a command or data received from another component (e.g., the sensor module 240 or the communication circuit 250) into a volatile memory of the memory 220, may process the command or data stored in the volatile memory, and may store the result data in a non-volatile memory.

For example, the memory 220 may store various pieces of data used by at least one component (e.g. the processor 210 or the sensor module 240) of the electronic device 200. The data may include, for example, software (e.g., a program) and input data or output data for a command associated with the software. The memory 220 may include a volatile memory or a nonvolatile memory. The program may be stored as software in the memory 220 and may include, for example, an operating system, middleware, or an application. The memory 220 may store, for example, instructions associated with various operations performed by the processor 210.

The speaker 231 may output, for example, an audio signal to the outside of the electronic device 200. Sound or a sound wave such as a voice may be introduced into the microphone 232, e.g., through a microphone hole in a housing of the electronic device. The microphone 232 may generate an electrical signal for the sound or the sound wave. The audio module 230 may convert sound into an electrical signal, or reversely, may convert an electrical signal into sound. The audio module 230 may obtain sound through the microphone 232 or may output sound through the speaker 231.

According to an embodiment, the audio module 230 may support an audio data collection function. The audio module 230 may play the collected audio data. The audio module 230 may include an audio decoder, a digital-to-analog (D/A) converter, or an analog-to-digital (A/D) converter. The audio decoder may convert the audio data stored in the memory 220 into a digital audio signal. The D/A converter may convert the digital audio signal converted by the audio decoder into an analog audio signal. The speaker 231 may output the analog audio signal converted by the D/A converter. The A/D converter may convert the analog audio signal obtained through the microphone 232 into a digital audio signal.

For example, the sensor module 240 may sense an operation state (e.g., power or a temperature) of the electronic device 200 or an external environment state (e.g., a user state) and may generate an electrical signal or a data value corresponding to the sensed state. According to an embodiment, the sensor module 240 may include, for example, one or more of an optical sensor, an acceleration sensor, a gyro sensor, a geomagnetic sensor, a magnetic sensor, a proximity sensor, a temperature sensor, a gesture sensor, a grip sensor, or a biometric sensor.

For example, the electronic device 200 may include an optical sensor at least partially located in a housing or on one surface of the housing. When the optical sensor is located in the housing, a partial area of the housing, which faces the optical sensor, may be implemented to pass light or may include an opening. The optical sensor may include an optical transmitter (e.g., a light emitting diode (LED)) for outputting light of at least one wavelength band or an optical receiver or detector (e.g., a photodiode) for receiving light of one or more wavelength bands to generate an electrical signal. According to an embodiment, the optical sensor may be a sensor for sensing that the electronic device is being worn. According to an embodiment, the optical sensor may be a biometric sensor. In a state in which the electronic device 200 is worn on eyes of a user, light output from the optical transmitter of the optical sensor may be reflected from the skin of the user and may then be introduced into the optical receiver of the optical sensor. The optical receiver of the optical sensor may provide the processor 210 with an electrical signal based on the introduced light. The processor 210 may transmit the electrical signal, obtained from the optical sensor, to an external electronic device (e.g., a smartphone) through the communication circuit 250. The external electronic device may obtain various pieces of biometric information, such as a heart rate or a skin temperature, based on the electrical signal obtained from the electronic device 200. According to various embodiments, the processor 210 may obtain biometric information based on the electrical signal obtained from the optical sensor and may transmit the obtained biometric information to the external electronic device through the communication circuit 250 or may output the obtained biometric information through the speaker 231.

According to various embodiments, information or a signal about whether the electronic device 200 is coupled to the eyes of the user may be obtained, for example, using the sensor module 240.

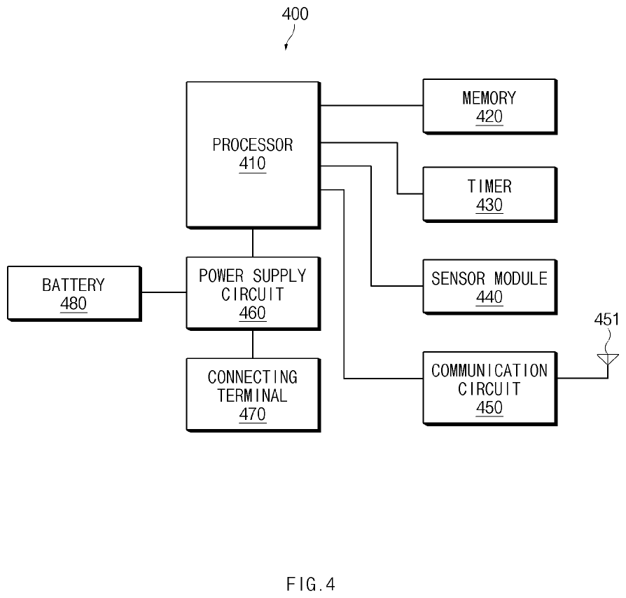

According to various embodiments, information or a signal about whether the electronic device 200 is coupled to an external electronic device (e.g., a cradle device for charging and receiving the electronic device 200) (e.g., a third electronic device 400 of FIG. 4 or a third electronic device 500 of FIG. 4) may be obtained, for example, using the sensor module 240.

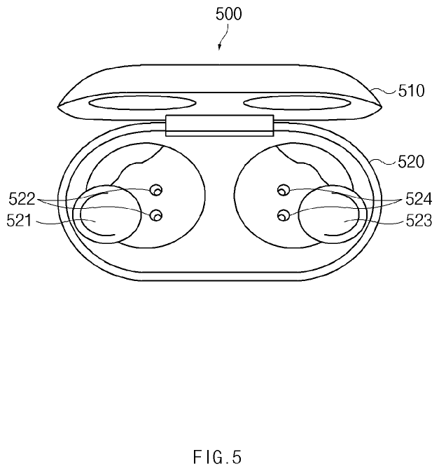

According to various embodiments, the connecting terminal 270 may include at least one contact (or terminal) (e.g., a first connecting terminal 311 of FIG. 3) disposed on an outer surface of the housing. For example, when the electronic device 200 is mounted on a mounting part (e.g., a first socket 521 or a second socket 523 of FIG. 5) of the external electronic device, at least one contact (e.g., the first connecting terminal 311 of FIG. 3) of the electronic device 200 may be electrically connected with at least one contact (e.g., a flexible terminal such as a pad or a pogo pin) (e.g., a third connecting terminal 522 or a fourth connecting terminal 524 of FIG. 5) disposed on the mounting part of the external electronic device. According to an embodiment, the connecting terminal 270 may receive power for charging the battery 280 of the electronic device 200 from the external electronic device and may deliver the received power to the charging circuit 260. According to an embodiment, the electronic device 200 may perform power line communication (PLC) with the external electronic device (e.g., the third electronic device 400 of FIG. 4 or the third electronic device 500 of FIG. 5) through the connecting terminal 270.

For example, the charging circuit 260 may manage power supplied to the electronic device 200. According to an embodiment, the charging circuit 260 may be implemented as at least a part of a power management integrated circuit (PMIC).

For example, the battery 280 may supply power to at least one component of the electronic device 200. According to an embodiment, the battery 280 may include a rechargeable secondary battery (e.g., a coin-type battery).

For example, the communication circuit 250 may establish a direct (e.g., wired) communication channel or a wireless communication channel between the electronic device 200 and an external electronic device (e.g., a server, a smartphone, a personal computer (PC), a personal digital assistant (PDA), a smart watch, or an access point (AP)) and may support to communicate over the established communication channel. According to various embodiments, the communication circuit 250 may include one or more communication processors capable of operating independently of the processor 210 and supporting direct (e.g., wired) communication or wireless communication.

For example, the communication circuit 250 may transmit a signal or power to the external electronic device through the at least one antenna (or antenna radiator) 251 or may receive a signal or power from the external electronic device through the at least one antenna (or antenna radiator) 251. According to an embodiment, the communication circuit 250 may include a wireless communication module (e.g., a short range wireless communication module or a global navigation satellite system (GNSS) communication module) or a wired communication module (e.g., a local area network (LAN) communication module or a power line communication module). The corresponding communication module among such communication modules may communicate with the external device over a first network (e.g., a short range communication network such as Bluetooth, Bluetooth low energy (BLE), near field communication (NFC), wireless-fidelity (Wi-Fi) Direct, or infrared data association (IrDA)) or a second network (e.g., a long range communication network such as the Internet or a computer network (e.g., a local area network (LAN) or a wide area network (WAN))). Such several types of communication modules may be integrated into one component (e.g., a single chip) or may be implemented as a plurality of components (e.g., a plurality of chips) independent of each other. According to various embodiments, the electronic device 200 may include a plurality of antennas 251. The communication circuit 250 may select at least one antenna suitable for a communication scheme used in the communication network from the plurality of antennas 251. The signal or power may be transmitted or received between the communication circuit 250 and the external electronic device through the selected at least one antenna.

According to an embodiment, all or some of the operations executed by the electronic device 200 may be executed by at least one external electronic device (e.g., a smartphone). For example, when the electronic device 200 should perform any function or service automatically or in response to a request from the user or any other device, it may request the at least one external electronic device to perform at least a part of the function or service, instead of internally executing the function or service or additionally. Receiving the request, the at least one external electronic device may execute at least a part of the requested function or service or may execute an additional function or service associated with the request and may deliver the result of the execution to the electronic device 200. The electronic device 200 may process the result as it is or perform additional processing and may provide the processed result as at least a part of the response to the request.

According to various embodiments, the command or data received in the processor 210 may be transmitted or received between the electronic device 200 and the external electronic device (e.g., the smartphone) through a server connected with the second network (e.g., the long range communication network such as the Internet or the computer network (e.g., the LAN or the WAN)).

According to an embodiment, the processor 210 may be configured to control various signal flow control about audio data and information collection and output. The processor 210 may be configured to receive audio data from the external electronic device (e.g., the server, the smartphone, the PC, the PDA, the smart watch, or the AP) through the communication circuit 250 and store the received audio data in the memory 220. The processor 210 may be configured to receive non-volatile audio data (or download audio data) from the external electronic device and store the received non-volatile audio data in the non-volatile memory. The processor 210 may be configured to receive volatile audio data (or streaming audio data) from the external electronic device and store the received volatile audio data in the volatile memory.

According to an embodiment, the processor 210 may be configured to play and output the audio data (e.g., the non-volatile audio data or the volatile audio data) stored in the memory 220 through the speaker 231. For example, the audio module 230 may decode audio data to generate an audio signal capable of being output through the speaker 231 (e.g., play audio data). The generated audio signal may be output through the speaker 231.

According to various embodiments, the processor 210 may be configured to receive an audio signal from the external electronic device and output the received audio signal through the speaker 231. For example, the external electronic device (e.g., an audio playback device) may decode audio data to generate an audio signal and may transmit the generated audio signal to the electronic device 200.

According to various embodiments, a mode in which the electronic device 200 plays and outputs the volatile audio data or the non-volatile audio data stored in the memory 220 through the speaker 231 may pause when a state in which the electronic device 200 is not coupled to the eyes of the user is identified using the sensor module 240. When a state in which the electronic device 200 is coupled to the eyes of the user is identified using the sensor module 240, the mode may resume.

According to various embodiments, a mode in which an audio signal is provided from the external electronic device to be output through the speaker 231 may be paused, when the state in which the electronic device 200 is not coupled to the eyes of the user is identified using the sensor module 240. When the state in which the electronic device 200 is coupled to the eyes of the user is identified by means of the sensor module 240, the mode may resume.

According to various embodiments, when the electronic device 200 is communicatively connected with another ear electronic device (e.g., the second electronic device 320 of FIG. 3), one ear electronic device may be a master device and the other ear electronic device may be a slave device. For example, the electronic device 200 which is the master device may output the audio signal received from the external electronic device (e.g., the smartphone) to the speaker 231 and may transmit the audio signal to the other ear electronic device (e.g., the second electronic device 320 of FIG. 3). The other ear electronic device may be implemented to be substantially the same as the electronic device 200 and may output the audio signal received from the electronic device 200 through its speaker.

According to various embodiments, the electronic device 200 may provide a speech recognition function of generating a voice command from the analog audio signal received through the microphone 232. The voice command may be used for various functions about audio data.

According to various embodiments, the electronic device 200 may include a plurality of microphones (e.g., the microphone 232) to detect a direction of sound. At least some of the plurality of microphones may be used for noise-cancelling.

According to various embodiments, the electronic device 200 may further include various modules depending on a provided form thereof. Numerous modifications may be made according to the convergence trend of a digital device, but a component(s) in the same level as the above-mentioned components may be further included in the electronic device 200. Furthermore, it is apparent that specific components are able to be excluded from the above-mentioned components or be replaced with other components according to a provided form thereof in the electronic device 200 according to an embodiment. This may be easily understood by those skilled in the art. According to various embodiments of the disclosure, the communication circuit 250 may perform data transmission or reception through wireless communication with another electronic device. According to an embodiment, the communication circuit 250 may support wireless communication (e.g., Bluetooth, Bluetooth low energy, or Wi-Fi) supportable by the other electronic device. The communication circuit 250 may perform various operations (e.g., advertisement signal output, paging signal output, wireless communication channel generation, or wireless communication channel release) using the supported wireless communication.

According to various embodiments, the memory 220 may store data received through the communication circuit 250 and/or the charging circuit 260 or information stored while manufacturing the electronic device 200. According to an embodiment, the memory 220 may store information for a wireless communication connection between the other electronic device and the electronic device 200. For example, the memory 220 may store address information of the other electronic device.

According to various embodiments, the charging circuit 260 may perform an operation associated with reception of power transmitted by the third electronic device (e.g., the third electronic device 400 of FIG. 4 or the third electronic device 500 of FIG. 5) (e.g., control of a receiving rate of the power or control of an operation of transmitting the received power to the battery 280 of the electronic device 200) through an electrical connection between the electronic device 200 and the third electronic device. The electronic device 200 may be electrically connected with the third electronic device in various schemes. According to an embodiment, the electronic device 200 may be electrically connected with the third electronic device through a contact between a terminal (e.g., the first connecting terminal 311 of FIG. 3) of the electronic device 200 and a terminal (e.g., the third connecting terminal 522 or the fourth connecting terminal 524 of FIG. 5) of the third electronic device. As the electrical connection between the terminal of the electronic device 200 and the terminal of the third electronic device is generated, the charging circuit 260 may receive power from the third electronic device. A communication channel between the electronic device 200 and the third electronic device may be generated. The charging circuit 260 may exchange various pieces of data with the third electronic device over the generated communication channel between the electronic device 200 and the third electronic device. The charging circuit 260 may transmit data, received from the third electronic device, to the processor 210,

According to various embodiments, the communication channel between the electronic device 200 and the third electronic device may be various types of communication channels capable of being implemented according to the electrical connection between the electronic device 200 and the third electronic device. According to an embodiment, the electrical connection between the electronic device 200 and the third electronic device may be generated by the contact between the terminal of the electronic device 200 and the terminal of the third electronic device. According to an embodiment, the communication channel between the electronic device 200 and the third electronic device may be a communication channel implemented with power line communication (PLC).

The electronic device 200 may transmit state information of the electronic device 200 (e.g., charging state information (e.g., remaining capacity state information, charging voltage information or temperature information) of the electronic device 200) or state information of the second electronic device (e.g., charging state information of the second electronic device 320 of FIG. 3) to the third electronic device over the communication channel generated according to the electrical connection between the electronic device 200 and the third electronic device and may receive a signal for controlling a charging state of the battery 280 of the electronic device 200 or a signal for controlling the electronic device 200 to activate or deactivate a sleep mode from the third electronic device.

According to various embodiments, the processor 210 may be electrically connected with various electronic parts (e.g., the communication circuit 250, the memory 220, and/or the charging circuit 260) included in the electronic device 200 and may control various parts electrically connected with the processor 210.

The components (e.g., the communication circuit 250, the processor 210, the memory 220, and/or the charging circuit 260) illustrated in FIG. 2 and the various embodiments are described as examples of the electronic device 200 (e.g., the first electronic device 310 of FIG. 3), but may also be applied to the second electronic device (e.g., the second electronic device 320 of FIG. 3) in the same manner.

FIG. 3 is a drawing schematically illustrating structures of example Bluetooth electronic devices constituting one set according to various embodiments.

Referring to FIG. 3, a first electronic device 310 (e.g., an electronic device 200 of FIG. 2) and a second electronic device 320 may perform wireless communication in a short range over a Bluetooth network defined by a Bluetooth special interest group (SIG). The Bluetooth network may include, for example, a Bluetooth legacy network and a Bluetooth low energy (BLE) network. According to an embodiment, the first electronic device 310 and the second electronic device 320 may perform wireless communication over one of the Bluetooth legacy network and the BLE network or may perform wireless communication over two of the Bluetooth legacy network and the BLE network.

According to an embodiment, the first electronic device 310 and the second electronic device 320 may be accessory devices (e.g., earphones) making up one set. For example, the first electronic device 310 and the second electronic device 320 may be devices which receive the same data (e.g., audio data) from one external electronic device (e.g., a smartphone). According to an embodiment, the first electronic device 310 and the second electronic device 320 may be in the form of wireless earphones respectively inserted into both ears of a user.

According to an embodiment, the first electronic device 310 may include a first connecting terminal 311.

According to an embodiment, the first electronic device 310 may perform charging through the first connecting terminal(s) 311. For example, the first connecting terminal 311 may be connected with a third connecting terminal 522 of a third electronic device 500 which will be described below with reference to FIG. 5 to receive power from the third electronic device 500. The first electronic device 310 may charge a battery (e.g., a battery 280 of FIG. 2) of the first electronic device 310 using the received power. According to an embodiment, when the first connecting terminal 311 is electrically connected with the third connecting terminal(s) 522 of the third electronic device 500, the first electronic device 310 may detect that the first electronic device is being charged.

According to an embodiment, the first electronic device 310 may communicate with the third electronic device 500 through the first connecting terminal 311. According to an embodiment, the first electronic device 310 may perform power line communication (PLC) with the third electronic device 500 through the first connecting terminal 311. The first electronic device 310 may transmit charging state information (e.g., remaining capacity state information, charging voltage information, and/or temperature information) of the first electronic device 310 to the third electronic device 500 over a communication channel generated as the first electronic device 310 and the third electronic device 500 are electrically connected with each other through the connecting terminal. The first electronic device 310 may receive a signal for controlling a charging state of the battery 280 of the first electronic device 310 or a signal for controlling the first electronic device 310 to activate or deactivate a sleep mode from the third electronic device 500 over the communication channel. The first electronic device 310 may receive charging state information (e.g., remaining capacity state information, charging voltage information, and/or temperature information) of the third electronic device 500, sensor information (e.g., temperature information), and/or time information from the third electronic device 500 over the communication channel.

According to an embodiment, the second electronic device 320 may include a second connecting terminal 321.

According to an embodiment, the second electronic device 320 may perform charging through the second connecting terminal(s) 321. For example, the second connecting terminal 321 may be connected with a fourth connecting terminal(s) 524 of the third electronic device 500 which will be described below with reference to FIG. 5 to receive power from the third electronic device 500. The second electronic device 320 may charge a battery of the second electronic device 320 using the received power. According to an embodiment, when the second connecting terminal 321 is electrically connected with the fourth connecting terminal 524 of the third electronic device 500, the second electronic device 320 may detect that the second electronic device 320 is being charged.

According to an embodiment, the second electronic device 320 may communicate with the third electronic device 500 through the second connecting terminal 321. For example, the second electronic device 320 may perform power line communication (PLC) with the third electronic device 500 through the second connecting terminal 321. The second electronic device 320 may transmit charging state information (e.g., remaining capacity state information, charging voltage information, and/or temperature information) of the first electronic device 310 to the third electronic device 500 over a communication channel generated as the second electronic device 320 and the third electronic device 500 are electrically connected with each other through the connecting terminal. The second electronic device 320 may receive a signal for controlling a charging state of the battery of the second electronic device 320 or a signal for controlling the second electronic device 320 to activate or deactivate the sleep mode from the third electronic device 500 over the communication channel. The second electronic device 320 may receive charging state information (e.g., remaining capacity state information, charging voltage information, and/or temperature information) of the third electronic device 500, sensor information (e.g., temperature information), and/or time information from the third electronic device 500 over the communication channel.

Hereinafter, a description will be given of the third electronic device according to an embodiment with reference to FIGS. 4 and 5.

FIG. 4 is a block diagram illustrating a configuration of an example third electronic device according to various embodiments.

Referring to FIG. 4, a third electronic device 400 (e.g., a third electronic device 500 of FIG. 5) may include a processor 410 (including, e.g., processing circuitry), memory 420, a timer 430, a sensor module 440 (including, e.g., at least one sensor), a communication circuit 450, at least one antenna 451, a power supply circuit 460, a connecting terminal 470, or a battery 480. According to various embodiments, the third electronic device 400 may not include at least one of the components of FIG. 4 or may further include one or more other components. According to various embodiments, some of the components may be implemented as one integrated circuit.

For example, the processor 410 may execute software to control at least one other component (e.g., a hardware or software component) of the third electronic device 400 connected with the processor 410 and may perform a variety of data processing and calculation. According to an embodiment, as at least a portion of data processing or calculation, the processor 410 may load a command or data received from another component (e.g., the sensor module 440 or the communication circuit 450) into a volatile memory of the memory 420, may process the command or data stored in the volatile memory, and may store the result data in a non-volatile memory.

For example, the memory 420 may store various pieces of data used by at least one component (e.g. the processor 410 or the sensor module 440) of the third electronic device 400. The data may include, for example, software (e.g., a program) and input data or output data for a command associated with the software. The memory 420 may include a volatile memory or a nonvolatile memory. The program may be stored as software in the memory 420, and may include, for example, an operating system, middleware, or an application. For example, the memory 420 may store instructions associated with various operations performed by the processor 410.

The timer 430 may include a circuit for maintaining time information of the third electronic device 400, for example, a real time clock (RTC). According to an embodiment, when activating a standby mode, the third electronic device 400 may operate the timer 430 using the processor 410. The timer 430 which is operating may deliver the time information of the third electronic device 400 to the processor 410. The timer 430 may be embedded in the processor 410 or may be a separate configuration disposed outside the processor 410.

According to an embodiment, the processor 410 may determine whether the third electronic device 500 deactivates the standby mode before a specified time elapses, based on time information received from the timer 430 and information about whether the standby mode is deactivated.

For example, the sensor module 440 may sense an operation state (e.g., power or a temperature) of the third electronic device 400 or an external environment state (e.g., an ambient temperature) and may generate an electrical signal or a data value corresponding to the sensed state. For example, the sensor module 440 may, for example, measure an internal temperature of the third electronic device 400, which varies with a change (an increase or a decrease) in the ambient temperature of the third electronic device 400, thus sensing the change in the ambient temperature of the third electronic device 400. According to an embodiment, the sensor module 440 may, for example, include one or more of an acceleration sensor, a gyro sensor, a geomagnetic sensor, a magnetic sensor, a proximity sensor, a temperature sensor, a gesture sensor, a grip sensor, or a biometric sensor.

According to various embodiments, the connecting terminal 470 may include at least one contact (or terminal) (e.g., a third connecting terminal 522 or a fourth connecting terminal 524 of FIG. 5) disposed on an outer surface of a housing. For example, when an external electronic device (e.g., a first electronic device 310 or a second electronic device 320 of FIG. 3) is mounted on a mounting part (e.g., a first socket 521 or a second socket 523 of FIG. 5) of the third electronic device 400, at least one contact (e.g., a first connecting terminal 311 or a second connecting terminal 321 of FIG. 3) of the external electronic device may be electrically connected with the at least one contact (e.g., a flexible terminal such as a pad or a pogo pin) (e.g., the third connecting terminal 522 or the fourth connecting terminal 524 of FIG. 5) disposed on the mounting part of the third electronic device 400. According to an embodiment, the third electronic device 400 may output a voltage for charging a battery of an external electronic device (e.g., the first electronic device 310 and/or the second electronic device 320 of FIG. 3) through the connecting terminal 470. According to an embodiment, the third electronic device 400 may communicate with the external electronic device (e.g., the first electronic device 310 or the second electronic device 320 of FIG. 3) through the connecting terminal 470. For example, the third electronic device 400 may perform power line communication (PLC) with the external electronic device (e.g., the first electronic device 310 or the second electronic device 320 of FIG. 3) through the connecting terminal 470.

According to an embodiment, the power supply circuit 460 may convert power stored in the battery 480 or power supplied from an external power device into a specified voltage and may output the converted voltage through the connecting terminal 470, when a connecting terminal (e.g., a first connecting terminal 311 or a second connecting terminal 321 of FIG. 3) of the external electronic device (e.g., the first electronic device 310 or the second electronic device 320 of FIG. 3) is connected with the connecting terminal 470 of the third electronic device 400.

For example, the battery 480 may supply power to at least one component of the third electronic device 400. According to an embodiment, the battery 480 may include a rechargeable secondary battery.

For example, the communication circuit 450 may establish a direct (e.g., wired) communication channel or a wireless communication channel between the third electronic device 400 and an external electronic device (e.g., a server, a smartphone, a personal computer (PC), a personal digital assistant (PDA), or an access point (AP)) and may support to communicate over the established communication channel. According to various embodiments, the communication circuit 450 may include one or more communication processors capable of operating independently of the processor 410 and supporting direct (e.g., wired) communication or wireless communication. According to an embodiment, the communication circuit 450 may be electrically connected with the power supply circuit 460 or may be included in the power supply circuit 460 to perform power line communication (PLC) with the external electronic device (e.g., the first electronic device 310 or the second electronic device 320 of FIG. 3) through the connecting terminal 470.

For example, the communication circuit 450 may transmit a signal or power to the external electronic device through the at least one antenna (or antenna radiator) 451 or may receive a signal or power from the external electronic device through the at least one antenna (or antenna radiator) 251. According to an embodiment, the communication circuit 450 may include a wireless communication module (e.g., a short range wireless communication module or a global navigation satellite system (GNSS) communication module) or a wired communication module (e.g., a local area network (LAN) communication module or a power line communication module). The corresponding communication module among such communication modules may communicate with the external device over a first network (e.g., a short range communication network such as Bluetooth, Bluetooth low energy (BLE), near field communication (NFC), wireless-fidelity (Wi-Fi) Direct, or infrared data association (IrDA)) or a second network (e.g., a long range communication network such as the Internet or a computer network (e.g., a local area network (LAN) or a wide area network (WAN))). Such several types of communication modules may be integrated into one component (e.g., a single chip) or may be implemented as a plurality of components (e.g., a plurality of chips) independent of each other. According to various embodiments, the third electronic device 400 may include a plurality of antennas 451. The communication circuit 450 may select at least one antenna suitable for a communication scheme used in the communication network from the plurality of antennas 451. The signal or power may be transmitted or received between the communication circuit 450 and the external electronic device through the selected at least one antenna.

According to an embodiment, all or some of the operations executed by the third electronic device 400 may be executed by at least one external electronic device (e.g., a smartphone). For example, when the third electronic device 400 should perform any function or service automatically or in response to a request from the user or any other device, it may request the at least one external electronic device to perform at least a part of the function or service, instead of internally executing the function or service or additionally. Receiving the request, the at least one external electronic device may execute at least a part of the requested function or service or may execute an additional function or service associated with the request and may deliver the result of the execution to the electronic device 400. The third electronic device 400 may process the result as it is or perform additional processing and may provide the processed result as at least a part of the response to the request.

According to various embodiments, the command or data received in the processor 410 may be transmitted or received between the third electronic device 400 and the external electronic device (e.g., the smartphone) through a server connected with the second network (e.g., the long range communication network such as the Internet or the computer network (e.g., the LAN or the WAN)).

According to various embodiments, the third electronic device 400 may further include various modules depending on a provided form thereof. Numerous modifications may be made according to the convergence trend of a digital device, but a component(s) in the same level as the above-mentioned components may be further included in the third electronic device 400. Furthermore, it is apparent that specific components are able to be excluded from the above-mentioned components and be replaced with other components according to a provided form thereof in the third electronic device 400 according to an embodiment. This may be easily understood by those skilled in the art. According to various embodiments of the disclosure, the communication circuit 450 may perform data transmission or reception through wireless communication with another electronic device. According to an embodiment, the communication circuit 450 may support wireless communication (e.g., Bluetooth, Bluetooth low energy, or Wi-Fi) supportable by the other electronic device. The communication circuit 450 may perform various operations (e.g., advertisement signal output, paging signal output, wireless communication channel generation, or wireless communication channel release) using the supported wireless communication.

According to various embodiments, the memory 420 may store data received through the communication circuit 450 and/or the power supply circuit 460 or information stored while manufacturing the third the third electronic device 400. According to an embodiment, the memory 420 may store information for a wireless communication connection between the other electronic device and the third the electronic device 400. For example, the memory 420 may store address information of the other electronic device.

According to various embodiments, the power supply circuit 460 may perform an operation associated with transmission of power to the external electronic device (e.g., the first electronic device 310 of FIG. 3 or the second electronic device 320 of FIG. 3) (e.g., control of an operation of transmitting power stored in the battery 480 of the third electronic device 400 or power supplied from the external electronic device to the external electronic device) through an electrical connection between the third electronic device 400 and the external electronic device. The third electronic device 400 may be electrically connected with the external electronic device in various schemes. According to an embodiment, the third electronic device 400 may be electrically connected with the external electronic device through a contact between the connecting terminal 470 (e.g., the third connecting terminal 522 or the fourth connecting terminal 524 of FIG. 5) and the terminal (e.g., the first connecting terminal 311 or the second connecting terminal 321 of FIG. 3) of the external electronic device. As an electrical connection between the connecting terminal 470 of the third electronic device 400 and the connecting terminal of the external electronic device is generated, the power supply circuit 460 may supply power to the external electronic device. A communication channel may be generated between the third electronic device 400 and the external electronic device. According to an embodiment, the power supply circuit 460 may perform power line communication (PLC) with the external electronic device over the communication channel. The power supply circuit 460 may transmit data, received from the external electronic device, to the processor 410.

According to various embodiments, the communication channel between the third electronic device 400 and the external electronic device (e.g., the first electronic device 310 of FIG. 3 or the second electronic device 320 of FIG. 3) may be various types of communication channels capable of being implemented according to the electrical connection between the third electronic device 400 and the external electronic device. According to an embodiment, the electrical connection between the third electronic device 400 and the external electronic device may be generated by a contact between the connecting terminal 470 of the third electronic device 400 and the connecting terminal (e.g., the first connecting terminal 311 or the second connecting terminal 321 of FIG. 3) of the external electronic device. According to an embodiment, the communication channel between the third electronic device 400 and the external electronic device may be a communication channel implemented with power line communication (PLC).

The third electronic device 400 may receive state information (e.g., remaining capacity state information, charging voltage information, and/or temperature information) of the external electronic device (e.g., the first electronic device 310 of FIG. 3 or the second electronic device 320 of FIG. 3) from the external electronic device over a communication channel generated according to the electrical connection between the third electronic device 400 and the external electronic device. The third electronic device 400 may transmit a signal for controlling a charging state of the battery of the external electronic device or a signal for controlling the external electronic device to activate or deactivate a sleep mode to the external electronic device over the communication channel. The third electronic device 400 may transmit charging state information (e.g., remaining capacity state information, charging voltage information, and/or temperature information) of the third electronic device 400, sensor information (e.g., temperature information), and/or time information to the external electronic device over the communication channel.

According to various embodiments, the processor 410 may be electrically connected with various electronic parts (e.g., the communication circuit 450, the memory 420, and/or the power supply circuit 460) included in the third electronic device 400 and may control various parts electrically connected with the processor 410.

FIG. 5 is a drawing schematically illustrating a structure of an example third electronic device according to various embodiments.

Referring to FIG. 5, a third electronic device 500 may include a body 520 and a lid 510. According to an embodiment, the third electronic device 500 may have a shape in which the lid 510 covers one surface of the body 520 as the body 520 and the lid 510 are connected with each other.

According to an embodiment, the body 520 of the third electronic device 500 may include a first socket 521 and/or a second socket 523 into which an external electronic device (e.g., a first electronic device 310 or a second electronic device 320 of FIG. 3) may be inserted. A third connecting terminal(s) 522 and/or a fourth connecting terminal(s) 524 may be located in the first socket 521 and/or the second socket 523, respectively. The third connecting terminal 522 and/or the fourth connecting terminal 524 may be connected with a connecting terminal (e.g., a first connecting terminal 311 or a second connecting terminal 321 of FIG. 3) of the external electronic device (e.g., the first electronic device 310 or the second electronic device 320 of FIG. 3) and may be used to supply power to the external electronic device or transmit and receive data (e.g., battery state information of the external electronic device, a signal for controlling a charging state of a battery of the external electronic device, or a signal for controlling the external electronic device to activate a sleep mode).

According to an embodiment, when the third connecting terminal 522 and/or the fourth connecting terminal 524 are/is electrically connected with the connecting terminal (e.g., the first connecting terminal 311 or the second connecting terminal 321 of FIG. 3) of the external electronic device (e.g., the first electronic device 310 or the second electronic device 320 of FIG. 3), the third electronic device 500 may detect that the external electronic device is being charged.

According to an embodiment, the third electronic device 500 may communicate with the external electronic device (e.g., the first electronic device 310 or the second electronic device 320 of FIG. 3) through the third connecting terminal 522 and/or the fourth connecting terminal 524. For example, the third electronic device 500 may perform power line communication (PLC) with the external electronic device through the third connecting terminal 522 and/or the fourth connecting terminal 524. The third electronic device 500 may receive charging state information (e.g., remaining capacity state information, charging voltage information, and/or temperature information) of the external electronic device from the external electronic device over a communication channel generated as the third electronic device 500 and the external electronic device are electrically connected with each other through the connecting terminal. The third electronic device 500 may transmit a signal for controlling a charging state of the battery of the external electronic device or a signal for controlling the external electronic device to activate or deactivate a sleep mode to the external electronic device over the communication channel. The third electronic device 500 may transmit charging state information (e.g., remaining capacity state information, charging voltage information, and/or temperature information) of the third electronic device 500, sensor information (e.g., temperature information), and/or time information to the external electronic device over the communication channel.

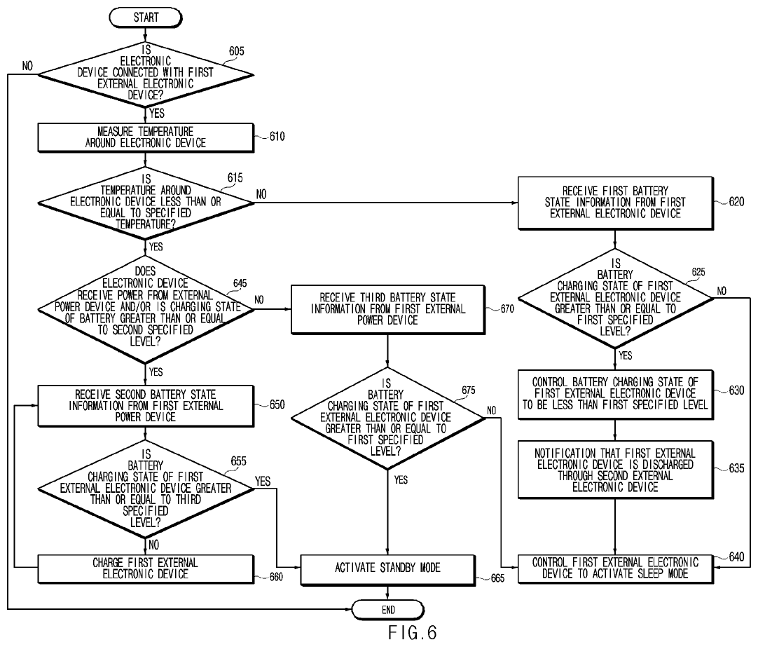

Hereinafter, a description will be given of an example operation of an example electronic device according to an according to various embodiments with reference to FIG. 6. Descriptions of the same configuration as the above-mentioned embodiments will not be repeated.

FIG. 6 is an operational flowchart of an electronic device according to various embodiments.

The embodiment illustrated in FIG. 6 is only a non-limiting, example embodiment. An operation order according to various embodiments disclosed in the disclosure may be different from that illustrated in FIG. 6. For example, some of operations illustrated in FIG. 6 may be omitted, an order among operations may be changed, or operations may be merged.

According to an embodiment, operations 605 to 675 may be understood as being performed by a processor (e.g., a processor 410 of FIG. 4) of an electronic device (e.g., a third electronic device 400 of FIG. 4 or a third electronic device 500 of FIG. 5).

Referring to FIG. 6, in operation 605, the electronic device may determine whether it is electrically connected with a first external electronic device (e.g., an electronic device 200 of FIG. 2, a first electronic device 310 of FIG. 3, or a second electronic device 320 of FIG. 3). According to an embodiment, the electronic device may, for example, detect a physical contact between a connecting terminal (e.g., a third connecting terminal 522 or a fourth connecting terminal 524 of FIG. 5) of the electronic device and a connecting terminal (e.g., a first connecting terminal 311 or a second connecting terminal 321 of FIG. 3) of the first external electronic device to determine that the electronic device and the first external electronic device are electrically connected with each other. According to an embodiment, when a voltage of the connecting terminal to be recognized is identified as being high, the electronic device may determine that it is electrically connected with the first external electronic device.

When the electronic device is determined to be electrically connected with the first external electronic device in operation 605, in operation 610, the electronic device may measure a temperature around the electronic device using a temperature sensor disposed in the electronic device. According to an embodiment, the electronic device may measure a temperature in the electronic device, which increases or decreases as the temperature around the electronic device increases or decreases, thus measuring the temperature around the electronic device. In other words, the electronic device may measure the temperature in the electronic device using the temperature sensor, thus detecting a change in the temperature around the electronic device. According to an embodiment, the temperature sensor may, for example, be disposed on a circuit board (not shown) in the electronic device.

In operation 615, the electronic device may determine whether the temperature around the electronic device, which is measured in operation 610, is less than or equal to a specified temperature. According to various embodiments, the specified temperature may be variously set in the electronic device. For example, the specified temperature may be variously set, for example, 40 degrees, 45 degrees, or 50 degrees.

When determining that the temperature around the electronic device is greater than the specified temperature in operation 615, in operation 620, the electronic device may receive first battery state information from the first external electronic device. According to various embodiments, a communication channel between the electronic device and the first external electronic device may include various types of communication channels including a direct (e.g., wired) communication channel and/or a wireless communication channel. According to various embodiments, the communication channel between the electronic device and the first external electronic device may be a power line communication (PLC) channel generated as the connecting terminal (e.g., the first connecting terminal 311 or the second connecting terminal 321 of FIG. 3) of the first external electronic device and the connecting terminal (e.g., the third connecting terminal 522 or the fourth connecting terminal 524 of FIG. 5) of the electronic device are in contact with each other. According to an embodiment, the electronic device may receive the first battery state information from the first external electronic device over a power line communication channel generated as the electronic device and the first external electronic device are electrically connected with each other through the connecting terminal. For example, the first battery state information may include information (e.g., remaining capacity state information, charging voltage information, and/or temperature information) about a charging state of a battery (e.g., a battery 280 of FIG. 2) of the first external electronic device. As another example, the first battery state information may include power setting information for charging the battery of the first external electronic device and/or request information.

In operation 625, the electronic device may determine whether a battery charging state of the first external electronic device is greater than or equal to a first specified level. According to an embodiment, the electronic device may determine whether the battery charging state of the first external electronic device is greater than or equal to the first specified level based on the first battery state information received in operation 620. According to various embodiments, the specified level may be variously set in the electronic device. For example, the first specified level may be variously set, for example, charging levels of 80%, 70%, or 60%.

When determining that the battery charging state of the first external electronic device is greater than or equal to the first specified level in operation 625, in operation 630, the electronic device may control the battery charging state of the first external electronic device to be less than the first specified level. According to various embodiments, the electronic device may transmit a first signal for controlling the battery charging state of the first external electronic device to be less than the first specified level to the first external electronic device over a direct (e.g., wired) communication channel and/or a wireless communication channel. According to an embodiment, the electronic device may transmit the first signal to the first external electronic device over a power line communication channel. Receiving the first signal, the first external electronic device may lower the battery charging state of the first external electronic device to be less than the first specified level using a discharging circuit in a processor (e.g., a processor 210 of FIG. 2) disposed in the first external electronic device. The discharging circuit may include, for example, a circuit for compulsorily consuming current and/or a circuit for limiting current, through specified repetition calculation. For example, the discharging circuit may be implemented using a processor (e.g., a processor 210 of FIG. 2), a memory (e.g., a memory 220 of FIG. 2), an audio module (e.g., an audio module 230 of FIG. 2), a sensor module (e.g., a sensor module 240), and/or a communication circuit (e.g., a communication circuit 250 of FIG. 2).

In operation 635, the electronic device may provide a user with a notification that the first external electronic device is discharged through a second external electronic device (e.g., a smartphone). According to various embodiments, the electronic device may transmit information that the first external electronic device is discharged to the second external electronic device through the communication circuit (e.g., the communication circuit 250 of FIG. 2). The second external electronic device may provide the user with the notification that the first external electronic device is discharged through a display (e.g., a display module 160 of FIG. 1) in response to receiving the information that the first external electronic device is discharged.

In operation 640, the electronic device may control the first external electronic device to activate a sleep mode. According to various embodiments, the electronic device may transmit a second signal for controlling the first external electronic device to activate the sleep mode to the first external electronic device over a direct (e.g., wired) communication channel and/or a wireless communication channel. According to an embodiment, the electronic device may transmit the second signal to the first external electronic device over a power line communication channel. Receiving the second signal, the first external electronic device may activate the sleep mode using a processor (e.g., a processor 210 of FIG. 2) disposed in the first external electronic device.

When determining that the battery charging state of the first external electronic device is greater than the first specified level in operation 625, in operation 640, the electronic device may control the first external electronic device to activate the sleep mode.

When determining that the temperature around the electronic device is less than or equal to the specified temperature in operation 615, in operation 645, the electronic device may determine whether the electronic device receives power from an external power device and/or whether a charging state of a battery (e.g., a battery 480 of FIG. 4) is greater than or equal to a second specified level.

According to an embodiment, the electronic device may determine whether the electronic device receives power in a wired and/or wireless manner from the external power device. According to an embodiment, the electronic device may determine whether the charging state of the battery is greater than or equal to the second specified level. According to various embodiments, the specified level may be variously set in the electronic device. For example, the second specified level may be variously set, for example, battery charging levels of 5%, 10%, or 15%.

When determining that the electronic device receives the power from the external power device and/or that the charging state of the battery is greater than or equal to the second specified level in operation 645, in operation 650, the electronic device may receive second battery state information from the first external power device. According to an embodiment, the electronic device may receive the second battery state information over the power line communication channel from the first external electronic device. For example, the second battery state information may include information (e.g., remaining capacity state information, charging voltage information, and/or temperature information) about a charging state of a battery of the first external electronic device. As another example, the second battery state information may include power setting information for charging the battery of the first external electronic device and/or request information.

In operation 655, the electronic device may determine whether the battery charging state of the first external electronic device is greater than or equal to a third specified level. According to an embodiment, the electronic device may determine whether the battery charging state of the first external electronic device is greater than or equal to the third specified level based on the second battery state information received in operation 650. According to various embodiments, the third specified level may be variously set in the electronic device. For example, the third specified level may be set to a battery charging level of 100%, that is, a fully charged state.

When determining that the battery charging state of the first external electronic device is not greater than or equal to the third specified level in operation 655, in operation 660, the electronic device may charge the first external electronic device. According to an embodiment, a power supply circuit (e.g., a power supply circuit 460 of FIG. 4) of the electronic device may convert power stored in the battery or power supplied from the external electronic device into a specified voltage and may output the converted voltage through a connecting terminal (e.g., a connecting terminal 470 of FIG. 4), thus supplying power to the first external electronic device.

When determining that the battery charging state of the first external electronic device is greater than or equal to the third specified level in operation 655, in operation 665, the electronic device may activate a standby mode. According to an embodiment, the electronic device may activate the standby mode of the electronic device using a processor (e.g., a processor 410 of FIG. 4).

According to an embodiment, when determining that the electronic device does not receive the power from the external power device and the charging state of the battery is less than the second specified level in operation 645, in operation 670, the electronic device may receive third battery state information from the first external power device. According to an embodiment, the electronic device may receive the third battery state information over the power line communication channel from the first external electronic device. For example, the third battery state information may include information (e.g., remaining capacity state information, charging voltage information, and/or temperature information) about the charging state of the battery of the first external electronic device. As another example, the third battery state information may include power setting information for charging the battery of the first external electronic device and/or request information.

In operation 675, the electronic device may determine whether a battery charging state of the first external electronic device is greater than or equal to a first specified level. According to an embodiment, the electronic device may determine whether the battery charging state of the first external electronic device is greater than or equal to the first specified level based on the third battery state information received in operation 670. According to various embodiments, the specified level may be variously set in the electronic device. For example, the first specified level may be variously set, for example, charging levels of 80%, 70%, or 60%.

When determining that the battery charging state of the first external electronic device is greater than or equal to the first specified level in operation 675, in operation 665, the electronic device may activate the standby mode.

When determining that the battery charging state of the first external electronic device is less than the first specified level in operation 675, in operation 640, the electronic device may control the first external electronic device to activate the sleep mode.

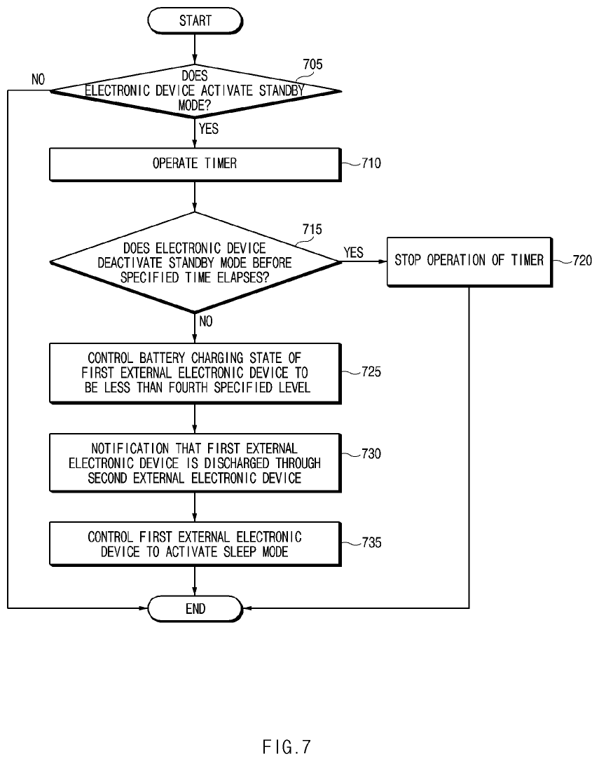

Hereinafter, a description will be given of an example operation of an example electronic device according to various embodiments with reference to FIG. 7.

FIG. 7 is an operational flowchart of an example electronic device according to various embodiments.

The embodiment illustrated in FIG. 7 is only a non-limiting, example embodiment. An operation order according to various embodiments disclosed in the disclosure may be different from that illustrated in FIG. 7. Some of operations illustrated in FIG. 7 may be omitted, an order among operations may be changed, or operations may be merged.

According to an embodiment, operations 705 to 735 may be understood as being performed by a processor (e.g., a processor 410 of FIG. 4) of an electronic device (e.g., a third electronic device 400 of FIG. 4 or a third electronic device 500 of FIG. 5).

Referring to FIG. 7, in operation 705, the electronic device may determine whether the electronic device activates a standby mode.

When determining that the electronic device activates the standby mode in operation 705, in operation 710, the electronic device may operate a timer (e.g., a timer 430 of FIG. 4). According to an embodiment, the electronic device may operate the timer using a processor (e.g., a processor 410 of FIG. 4). The timer which is operating may deliver time information of the electronic device to the processor.

In operation 715, the electronic device may determine whether the electronic device deactivates the standby mode before a specified time elapses. According to an embodiment, the processor of the electronic device may determine whether the electronic device deactivates the standby mode before the specified time elapses based on information about whether the standby mode is deactivated and the time information received from the timer. For example, the electronic device may deactivate the standby mode, when a lid (e.g., a lid 510 of FIG. 5) is open, thus determining that the electronic device deactivates the standby mode. As another example, the electronic device may deactivate the standby mode, when an electrical connection with a first external electronic device (e.g., an electronic device 200 of FIG. 2, a first electronic device 310 of FIG. 3, or a second electronic device 320 of FIG. 3) is disconnected, thus determining that the electronic device deactivates the standby mode. According to various embodiments, the specified time may be variously set in the electronic device.

When determining that the electronic device deactivates the standby mode before the specified time elapses in operation 715, in operation 720, the electronic device may stop the operation of the timer.

When determining that the electronic device does not deactivate the standby mode before the specified time elapses in operation 715, in operation 725, the electronic device may control a battery charging state of the first external electronic device to be less than a fourth specified level. According to various embodiments, the fourth specified level may be variously set in the electronic device. For example, the fourth specified level may be variously set, for example, battery charging levels of 80%, 70%, or 60%. According to an embodiment, the fourth specified level may be the same as a first specified level in FIG. 6. According to various embodiments, the electronic device may transmit a first signal for controlling the battery charging state of the first external electronic device to be less than the fourth specified level to the first external electronic device over a direct (e.g., wired) communication channel and/or a wireless communication channel. According to an embodiment, the electronic device may transmit the first signal to the first external electronic device over a power line communication channel. Receiving the first signal, the first external electronic device may lower the battery charging state of the first external electronic device to be less than the fourth specified level using a discharging circuit in a processor (e.g., a processor 210 of FIG. 1) disposed in the first external electronic device. The discharging circuit may include, for example, a circuit for compulsorily consuming current and/or a circuit for limiting current, through specified repetition calculation. For example, the discharging circuit may be implemented using the processor (e.g., the processor 210 of FIG. 2), a memory (e.g., a memory 220 of FIG. 2), an audio module (e.g., an audio module 230 of FIG. 2), a sensor module (e.g., a sensor module 240), and/or a communication circuit (e.g., a communication circuit 250 of FIG. 2).

In operation 730, the electronic device may provide a user with a notification that the first external electronic device is discharged through a second external electronic device (e.g., a smartphone). According to various embodiments, the electronic device may transmit information that the first external electronic device is discharged to the second external electronic device through the communication circuit (e.g., the communication circuit 250 of FIG. 2). The second external electronic device may provide the user with the notification that the first external electronic device is discharged through a display (e.g., a display module 160 of FIG. 1) in response to receiving the information that the first external electronic device is discharged.

In operation 735, the electronic device may control the first external electronic device to activate a sleep mode. According to an embodiment, the electronic device may transmit a second signal for controlling the first external electronic device to activate the sleep mode to the first external electronic device over a power line communication channel. Receiving the second signal, the first external electronic device may activate the sleep mode using the processor (e.g., the processor 210 of FIG. 2).

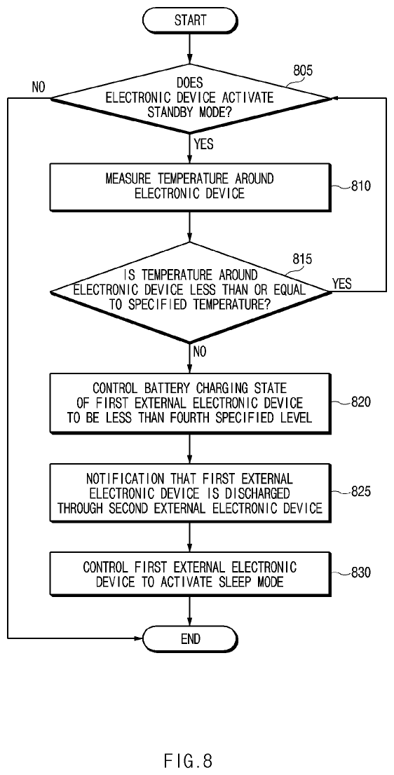

Hereinafter, a description will be given of an example operation of an example electronic device according to various embodiments with reference to FIG. 8.

FIG. 8 is an operational flowchart of an example electronic device according to various embodiments.

The embodiment illustrated in FIG. 8 is only a non-limiting, example embodiment. An operation order according to various embodiments disclosed in the disclosure may be different from that illustrated in FIG. 8. Some of operations illustrated in FIG. 8 may be omitted, an order among operations may be changed, or operations may be merged.

According to an embodiment, operations 805 to 830 may be understood as being performed by a processor (e.g., a processor 410 of FIG. 4) of an electronic device (e.g., a third electronic device 400 of FIG. 4 or a third electronic device 500 of FIG. 5).

Referring to FIG. 8, in operation 805, the electronic device may determine whether the electronic device activates a standby mode.

When determining that the electronic device activates the standby mode in operation 805, in operation 810, the electronic device may measure a temperature around the electronic device using a temperature sensor disposed in the electronic device. According to an embodiment, the electronic device may measure a temperature in the electronic device, which increases or decreases as the temperature around the electronic device increases or decreases, thus measuring the temperature around the electronic device. In other words, the electronic device may measure the temperature in the electronic device using the temperature sensor, thus detecting a change in the temperature around the electronic device.

In operation 815, the electronic device may determine the temperature around the electronic device is less than or equal to a specified temperature. According to various embodiments, the specified temperature may be variously set in the electronic device. For example, the specified temperature may be variously set, for example, 40 degrees, 45 degrees, or 50 degrees.

When determining that the temperature around the electronic device is less than or equal to the specified temperature in operation 815, the electronic device may return to operation 805 to determine whether the electronic device activates the standby mode.

When determining whether the temperature around the electronic device is greater than the specified temperature in operation 815, in operation 820, the electronic device may control a battery charging state of a first external electronic device (e.g., an electronic device 200 of FIG. 2, a first electronic device 310 of FIG. 3, or a second electronic device 320 of FIG. 3) to be less than a fourth specified level. According to various embodiments, the fourth specified level may be variously set in the electronic device. For example, the fourth specified level may be variously set, for example, battery charging levels of 80%, 70%, or 60%. According to an embodiment, the fourth specified level may be the same as a first specified level in FIG. 6. According to various embodiments, the electronic device may transmit a first signal for controlling the battery charging state of the first external electronic device to be less than the fourth specified level to the first external electronic device over a direct (e.g., wired) communication channel and/or a wireless communication channel. According to an embodiment, the electronic device may transmit the first signal to the first external electronic device over a power line communication channel. Receiving the first signal, the first external electronic device may lower the battery charging state of the first external electronic device to be less than the fourth specified level using a discharging circuit in a processor (e.g., a processor 210 of FIG. 1) disposed in the first external electronic device. The discharging circuit may include, for example, a circuit for compulsorily consuming current and/or a circuit for limiting current, through specified repetition calculation. For example, the discharging circuit may be implemented using the processor (e.g., the processor 210 of FIG. 2), a memory (e.g., a memory 220 of FIG. 2), an audio module (e.g., an audio module 230 of FIG. 2), a sensor module (e.g., a sensor module 240), and/or a communication circuit (e.g., a communication circuit 250 of FIG. 2).

In operation 825, the electronic device may provide a user with a notification that the first external electronic device is discharged through a second external electronic device (e.g., a smartphone). According to various embodiments, the electronic device may transmit information that the first external electronic device is discharged to the second external electronic device through the communication circuit (e.g., the communication circuit 250 of FIG. 2). The second external electronic device may provide the user with the notification that the first external electronic device is discharged through a display (e.g., a display module 160 of FIG. 1) in response to receiving the information that the first external electronic device is discharged.

In operation 830, the electronic device may control the first external electronic device to activate a sleep mode. According to an embodiment, the electronic device may transmit a second signal for controlling the first external electronic device to activate the sleep mode to the first external electronic device over a power line communication channel. Receiving the second signal, the first external electronic device may activate the sleep mode using the processor (e.g., the processor 210 of FIG. 2).

An electronic device according to various embodiments disclosed in the disclosure may include a temperature sensor, a battery, a communication circuit, a connecting terminal for a connection with an external electronic device, a processor electrically connected with the temperature sensor, the battery, and the communication circuit, and memory electrically connected with the processor. The memory may store instructions which, when executed, cause the processor to control the electronic device to determine whether the connecting terminal is electrically connected with the external electronic device; measure a first temperature around the electronic device using the temperature sensor, based on determining that the connecting terminal is connected with the external electronic device; receive first battery state information from the external electronic device through the communication circuit, based on the measured first temperature being greater than a specified temperature, the first battery information including information about a charging state of a battery of the external electronic device; determine a first charging state of the battery of the external electronic device, based on the received first battery state information; and transmit a first signal for controlling the charging state of the battery of the external electronic device to be less than a first specified level to the external electronic device through the communication circuit, based on determining that the first charging state of the battery of the external electronic device is greater than or equal to the first specified level.

According to various embodiments disclosed in the disclosure, the instructions may cause the processor to control the electronic device to transmit a second signal for controlling the external electronic device to activate a sleep mode to the external electronic device through the communication circuit, after transmitting the first signal to the external electronic device through the communication circuit.

According to various embodiments disclosed in the disclosure, the instructions may cause the processor to control the electronic device to transmit a second signal for controlling the external electronic device to activate a sleep mode to the external electronic device through the communication circuit, based on determining that the first charging state of the battery of the external electronic device is less than the first specified level.

According to various embodiments disclosed in the disclosure, the instructions may cause the processor to control the electronic device to determine whether the electronic device receives power from an external power source, based on the measured first temperature being less than or equal to the specified temperature; receive second battery state information from the external electronic device through the communication circuit, based on determining that the electronic device receives the power from the external electronic device, the second battery state information including information about a second charging state of the battery of the external electronic device; determine the second charging state of the battery of the external electronic device, based on the received second battery state information; and charge the external electronic device, based on determining that the second charging state of the battery of the external electronic device is less than a third specified level.

According to various embodiments disclosed in the disclosure, the instructions may cause the processor to control the electronic device to determine a third charging state of the battery of the electronic device, based on the measured first temperature being less than or equal to the specified temperature; receive second battery state information from the external electronic device through the communication circuit, based on determining that the third charging state of the battery of the electronic device is greater than or equal to a second specified level, the second battery state information including information about a second charging state of the battery of the external electronic device; determine the second charging state of the battery of the external electronic device, based on the received second battery state information; and charge the external electronic device, based on determining that the second charging state of the battery of the external electronic device is less than a third specified level.

According to various embodiments disclosed in the disclosure, the instructions may cause the processor to control the electronic device to activate a standby mode, based on determining that the second charging state of the battery of the external electronic device is greater than or equal to the third specified level.

The electronic device according to various embodiments disclosed in the disclosure may further include a timer for maintaining time information of the electronic device. The timer may be electrically connected with the processor. The instructions may cause the processor to control the electronic device to determine whether the electronic device activates a standby mode; operate the timer to receive the time information of the electronic device from the timer, based on determining that the electronic device activates the standby mode; determine whether the electronic device deactivates the standby mode before a specified time elapses, based on the received time information; and transmit a third signal for controlling the charging state of the battery of the external electronic device to be less than a fourth specified level to the external electronic device through the communication circuit, based on determining that the electronic device does not deactivate the standby mode before the specified time elapses.

According to various embodiments disclosed in the disclosure, the instructions may cause the processor to control the electronic device to transmit a fourth signal for controlling the external electronic device to activate a sleep mode to the external electronic device through the communication circuit, after transmitting the third signal to the external electronic device through the communication circuit.

According to various embodiments disclosed in the disclosure, the instructions may cause the processor to control the electronic device to determine whether the electronic device activates a standby mode, measure a second temperature around the electronic device using the temperature sensor, based on determining that the electronic device activates the standby mode; determine whether the measured second temperature is greater than the specified temperature; and transmit a third signal for controlling the charging state of the battery of the external electronic device to be less than a fourth specified level to the external electronic device through the communication circuit, based on the measured second temperature being greater than the specified temperature.

According to various embodiments disclosed in the disclosure, the instructions may cause the processor to control the electronic device to transmit a fourth signal for controlling the external electronic device to activate a sleep mode to the external electronic device through the communication circuit, after transmitting the third signal to the external electronic device through the communication circuit.

An operation method of an electronic device according to various embodiments disclosed in the disclosure may include determining whether a connecting terminal of the electronic device is electrically connected with an external electronic device; measuring a first temperature around the electronic device using a temperature sensor of the electronic device, based on determining that the connecting terminal is connected with the external electronic device; receiving first battery state information from the external electronic device through a communication circuit of the electronic device, based on the measured first temperature being greater than a specified temperature, the first battery information including information about a charging state of a battery of the external electronic device; determining a first charging state of the battery of the external electronic device, based on the received first battery state information; and transmitting a first signal for controlling the charging state of the battery of the external electronic device to be less than a first specified level to the external electronic device through the communication circuit, based on determining that the first charging state of the battery of the external electronic device is greater than or equal to the first specified level.

The operation method of the electronic device according to various embodiments disclosed in the disclosure may further include transmitting a second signal for controlling the external electronic device to activate a sleep mode to the external electronic device through the communication circuit, after transmitting the first signal to the external electronic device through the communication circuit.

The operation method of the electronic device according to various embodiments disclosed in the disclosure may further include transmitting a second signal for controlling the external electronic device to activate a sleep mode to the external electronic device through the communication circuit, based on determining that the first charging state of the battery of the external electronic device is less than the first specified level.

The operation method of the electronic device according to various embodiments disclosed in the disclosure may further include determining whether the electronic device receives power from an external power source, based on the measured first temperature being less than or equal to the specified temperature; receiving second battery state information from the external electronic device through the communication circuit, based on determining that the electronic device receives the power from the external electronic device, the second battery state information including information about a second charging state of the battery of the external electronic device; determining the second charging state of the battery of the external electronic device, based on the received second battery state information; and charging the external electronic device, based on determining that the second charging state of the battery of the external electronic device is less than a third specified level.

The operation method of the electronic device according to various embodiments disclosed in the disclosure may further include determining a third charging state of the battery of the electronic device, based on the measured first temperature being less than or equal to the specified temperature; receiving second battery state information from the external electronic device through the communication circuit, based on determining that the third charging state of the battery of the electronic device is greater than or equal to a second specified level, the second battery state information including information about a second charging state of the battery of the external electronic device; determining the second charging state of the battery of the external electronic device, based on the received second battery state information; and charging the external electronic device, based on determining that the second charging state of the battery of the external electronic device is less than a third specified level.

The operation method of the electronic device according to various embodiments disclosed in the disclosure may further include activating a standby mode, based on determining that the second charging state of the battery of the external electronic device is greater than or equal to the third specified level.

The operation method of the electronic device according to various embodiments disclosed in the disclosure may further include determining whether the electronic device activates a standby mode; operating a timer of the electronic device to obtain time information of the electronic device from the timer, based on determining that the electronic device activates the standby mode; determining whether the electronic device deactivates the standby mode before a specified time elapses, based on the received time information; and transmitting a third signal for controlling the charging state of the battery of the external electronic device to be less than a fourth specified level, based on determining that the electronic device does not deactivate the standby mode before the specified time elapses.

The operation method of the electronic device according to various embodiments disclosed in the disclosure may further include transmitting a fourth signal for controlling the external electronic device to activate a sleep mode to the external electronic device through the communication circuit, after transmitting the third signal to the external electronic device through the communication circuit.

The operation method of the electronic device according to various embodiments disclosed in the disclosure may further include determining whether the electronic device activates a standby mode; measuring a second temperature around the electronic device using the temperature sensor, based on determining that the electronic device activates the standby mode; determining whether the measured second temperature is greater than the specified temperature; and transmitting a third signal for controlling the charging state of the battery of the external electronic device to be less than a fourth specified level to the external electronic device through the communication circuit, based on the measured second temperature being greater than the specified temperature.

The operation method of the electronic device according to various embodiments disclosed in the disclosure may further include transmitting a fourth signal for controlling the external electronic device to activate a sleep mode to the external electronic device through the communication circuit, after transmitting the third signal to the external electronic device through the communication circuit.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to various embodiments of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, terms such as “1st” and “2nd,” or “first” and “second” may be used to simply distinguish a corresponding component from another, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or combinations thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium, where the term “non-transitory” simply means that the storage medium is a tangible device, and does not include a signal (e.g., an electromagnetic wave); but this term does not differentiate between data being semi-permanently stored in the storage medium and the data being temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities and some of multiple entities may be separately disposed on the other components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to embodiments disclosed in the disclosure, the electronic device may control a charging state of a battery of an external electronic device, when the external electronic device is exposed to a high-temperature environment or is left unattended for a long period of time, thus, for example, reducing potential damage of the battery such as heat generation, shortened lifespan, and/or a swelling phenomenon.

In addition, various effects ascertained directly or indirectly through the disclosure may be provided.

While the disclosure has been shown and described with reference to various embodiments thereof, it will be understood by those skilled in the art that various changes in form and details may be made therein without departing from the spirit and scope of the disclosure as defined by the appended claims and their equivalents. It will also be understood that any of the embodiment(s) described herein may be used in conjunction with any other embodiment(s) described herein.

What is claimed is:

1. An electronic device, comprising:
a temperature sensor;
a battery;
a communication circuit;
a connecting terminal for a connection with an external electronic device;
a processor electrically connected with the temperature sensor, the battery, and the communication circuit; and
memory electrically connected with the processor,
wherein the memory stores instructions which, when executed, cause the processor to control the electronic device to:
determine whether the connecting terminal is electrically connected with the external electronic device;
measure a first temperature around the electronic device using the temperature sensor, based on determining that the connecting terminal is connected with the external electronic device;
receive first battery state information from the external electronic device through the communication circuit, based on the measured first temperature being greater than a specified temperature, the first battery information including information about a charging state of a battery of the external electronic device;
determine a first charging state of the battery of the external electronic device, based on the received first battery state information; and
transmit a first signal for controlling the charging state of the battery of the external electronic device to be less than a first specified level to the external electronic device through the communication circuit, based on determining that the first charging state of the battery of the external electronic device is greater than or equal to the first specified level.

2. The electronic device of claim 1, wherein the instructions cause the processor to control the electronic device to:
transmit a second signal for controlling the external electronic device to activate a sleep mode to the external electronic device through the communication circuit, after transmitting the first signal to the external electronic device through the communication circuit.

3. The electronic device of claim 1, wherein the instructions cause the processor to control the electronic device to:
transmit a second signal for controlling the external electronic device to activate a sleep mode to the external electronic device through the communication circuit, based on determining that the first charging state of the battery of the external electronic device is less than the first specified level.

4. The electronic device of claim 1, wherein the instructions cause the processor to control the electronic device to:
determine whether the electronic device receives power from an external power source, based on the measured first temperature being less than or equal to the specified temperature;
receive second battery state information from the external electronic device through the communication circuit, based on determining that the electronic device receives the power from the external electronic device, the second battery state information including information about a second charging state of the battery of the external electronic device;
determine the second charging state of the battery of the external electronic device, based on the received second battery state information; and
charge the external electronic device, based on determining that the second charging state of the battery of the external electronic device is less than a third specified level.

5. The electronic device of claim 1, wherein the instructions cause the processor to control the electronic device to:
determine a third charging state of the battery of the electronic device, based on the measured first temperature being less than or equal to the specified temperature;
receive second battery state information from the external electronic device through the communication circuit, based on determining that the third charging state of the battery of the electronic device is greater than or equal to a second specified level, the second battery state information including information about a second charging state of the battery of the external electronic device;
determine the second charging state of the battery of the external electronic device, based on the received second battery state information; and
charge the external electronic device, based on determining that the second charging state of the battery of the external electronic device is less than a third specified level.

6. The electronic device of claim 4, wherein the instructions cause the processor to control the electronic device to:
activate a standby mode, based on determining that the second charging state of the battery of the external electronic device is greater than or equal to the third specified level.

7. The electronic device of claim 1, further comprising:
a timer configured to maintain time information of the electronic device,
wherein the timer is electrically connected with the processor, and
wherein the instructions cause the processor to control the electronic device to:
determine whether the electronic device activates a standby mode;
operate the timer to receive the time information of the electronic device from the timer, based on determining that the electronic device activates the standby mode;
determine whether the electronic device deactivates the standby mode before a specified time elapses, based on the received time information; and
transmit a third signal for controlling the charging state of the battery of the external electronic device to be less than a fourth specified level to the external electronic device through the communication circuit, based on determining that the electronic device does not deactivate the standby mode before the specified time elapses.

8. The electronic device of claim 7, wherein the instructions cause the processor to control the electronic device to:
transmit a fourth signal for controlling the external electronic device to activate a sleep mode to the external electronic device through the communication circuit, after transmitting the third signal to the external electronic device through the communication circuit.

9. The electronic device of claim 1, wherein the instructions cause the processor to control the electronic device to:
determine whether the electronic device activates a standby mode;
measure a second temperature around the electronic device using the temperature sensor, based on determining that the electronic device activates the standby mode;
determine whether the measured second temperature is greater than the specified temperature; and
transmit a third signal for controlling the charging state of the battery of the external electronic device to be less than a fourth specified level to the external electronic device through the communication circuit, based on the measured second temperature being greater than the specified temperature.

10. The electronic device of claim 9, wherein the instructions cause the processor to control the electronic device to:
transmit a fourth signal for controlling the external electronic device to activate a sleep mode to the external electronic device through the communication circuit, after transmitting the third signal to the external electronic device through the communication circuit.

11. An operation method of an electronic device, the operation method comprising:
determining whether a connecting terminal of the electronic device is electrically connected with an external electronic device;
measuring a first temperature around the electronic device using a temperature sensor of the electronic device, based on determining that the connecting terminal is connected with the external electronic device;
receiving first battery state information from the external electronic device through a communication circuit of the electronic device, based on the measured first temperature being greater than a specified temperature, the first battery information including information about a charging state of a battery of the external electronic device;
determining a first charging state of the battery of the external electronic device, based on the received first battery state information; and
transmitting a first signal for controlling the charging state of the battery of the external electronic device to be less than a first specified level to the external electronic device through the communication circuit, based on determining that the first charging state of the battery of the external electronic device is greater than or equal to the first specified level.

12. The operation method of claim 11, further comprising:
transmitting a second signal for controlling the external electronic device to activate a sleep mode to the external electronic device through the communication circuit, after transmitting the first signal to the external electronic device through the communication circuit.

13. The operation method of claim 11, further comprising:
transmitting a second signal for controlling the external electronic device to activate a sleep mode to the external electronic device through the communication circuit, based on determining that the first charging state of the battery of the external electronic device is less than the first specified level.

14. The operation method of claim 11, further comprising:
determining whether the electronic device receives power from an external power source, based on the measured first temperature being less than or equal to the specified temperature;
receiving second battery state information from the external electronic device through the communication circuit, based on determining that the electronic device receives the power from the external electronic device, the second battery state information including information about a second charging state of the battery of the external electronic device;
determining the second charging state of the battery of the external electronic device, based on the received second battery state information; and
charging the external electronic device, based on determining that the second charging state of the battery of the external electronic device is less than a third specified level.

15. The operation method of claim 11, further comprising:
determining a third charging state of the battery of the electronic device, based on the measured first temperature being less than or equal to the specified temperature;
receiving second battery state information from the external electronic device through the communication circuit, based on determining that the third charging state of the battery of the electronic device is greater than or equal to a second specified level, the second battery state information including information about a second charging state of the battery of the external electronic device;
determining the second charging state of the battery of the external electronic device, based on the received second battery state information; and
charging the external electronic device, based on determining that the second charging state of the battery of the external electronic device is less than a third specified level.

16. The operation method of claim 15, further comprising:
activating a standby mode, based on determining that the second charging state of the battery of the external electronic device is greater than or equal to the third specified level.

17. The operation method of claim 11, further comprising:
determining whether the electronic device activates a standby mode;
operating a timer of the electronic device to obtain time information of the electronic device from the timer, based on determining that the electronic device activates the standby mode;
determining whether the electronic device deactivates the standby mode before a specified time elapses, based on the received time information; and
transmitting a third signal for controlling the charging state of the battery of the external electronic device to be less than a fourth specified level, based on determining that the electronic device does not deactivate the standby mode before the specified time elapses.

18. The operation method of claim 17, further comprising:
transmitting a fourth signal for controlling the external electronic device to activate a sleep mode to the external electronic device through the communication circuit, after transmitting the third signal to the external electronic device through the communication circuit.

19. The operation method of claim 11, further comprising:
determining whether the electronic device activates a standby mode;
measuring a second temperature around the electronic device using the temperature sensor, based on determining that the electronic device activates the standby mode;
determining whether the measured second temperature is greater than the specified temperature; and
transmitting a third signal for controlling the charging state of the battery of the external electronic device to be less than a fourth specified level to the external electronic device through the communication circuit, based on the measured second temperature being greater than the specified temperature.

20. The operation method of claim 19, further comprising:
transmitting a fourth signal for controlling the external electronic device to activate a sleep mode to the external electronic device through the communication circuit, after transmitting the third signal to the external electronic device through the communication circuit.
